(19) United States
(12) Patent Application Publication
(10) Pub. No.: US 2020/0074539 A1
(43) Pub. Date: Mar. 5, 2020

(54) DEBT RESOLUTION PLANNING PLATFORM

(71) Applicant: Capital One Services, LLC, McLean, VA (US)

(72) Inventors: Ana PALAGHITA, Glen Allen, VA (US); Vineet GOYAL, Glen Allen, VA (US); Megan EDDS, Glen Allen, VA (US); Brekan KOHLITZ, Glen Allen, VA (US); Philip HERTZLER, Glen Allen, VA (US); William C. MOUNTJOY, Richmond, VA (US); Mary WOLFE, Midlothian, VA (US); Jason FERRELL, Richmond, VA (US)

(21) Appl. No.: 16/119,040

(22) Filed: Aug. 31, 2018

(51) Int. Cl. G06Q 40/02

(52) U.S. Cl. CPC G06Q 40/025

(57) ABSTRACT

A device receives a request for information regarding a debt resolution plan available for a delinquent account. The request includes a first input indicating a payment amount, a second input indicating a payment frequency, and a third input indicating a payment start date. The device obtains account data associated with the delinquent account and determines, using a first model, a score for the delinquent account based on the first input, the second input, the third input, and the account data. The device determines, using a second model, a plurality of debt resolution plan parameters for at least a first and a second debt resolution plan. The device transmits the plurality of debt resolution plan parameters associated with the first and second debt resolution plans, receives an enrollment request, enrolls the delinquent account in a selected debt resolution plan, and causes an action to be performed based on the enrolling.

### BACKGROUND

A user may employ a third-party credit counseling firm to implement a debt management plan on the user's behalf. Implementing a debt management plan may entail generating a formal agreement between the user, the third-party credit counseling firm, and one or more creditors. During formation of the debt management plan, the third-party credit counseling firm and the one or more creditors may establish an arbitrary payment amount and set a payment schedule. The user may subsequently be presented with the payment amount and payment schedule, and agree to make payments to the third-party credit counseling firm. The third-party credit counseling firm may then allocate the payments among the one or more creditors.

### SUMMARY

According to some possible implementations, a method may include receiving a request for information regarding a debt resolution plan available for a delinquent account, wherein the request includes a first input indicating a payment amount, second input indicating a payment frequency, and a third input indicating a payment start date. The method may include obtaining account data associated with the delinquent account, and determining, using a first model, a score for the delinquent account based on the first input, the second input, the third input, and the account data. The score may predict an ability to convert the delinquent account from a delinquent status to a current status. The method may include determining, using a second model, a plurality of debt resolution plan parameters, for at least a first debt resolution plan and a second debt resolution plan, based on the score. The plurality of debt resolution plan parameters may include at least a first parameter indicating a repayment amount, a second parameter indicating a repayment frequency, and a third parameter indicating a repayment start date. The method may include transmitting the plurality of debt resolution plan parameters associated with the first debt resolution plan and the second debt resolution plan. The method may include receiving an enrollment request based on transmitting the plurality of debt resolution plan parameters. The method may include enrolling the delinquent account in a selected debt resolution plan based on receiving the enrollment request, and causing an action to be performed based on enrolling the delinquent account in the selected debt resolution plan.

According to some possible implementations, a device may include one or more memories, and one or more processors, communicatively coupled to the one or more memories, to receive a request for information regarding a debt resolution plan available for a delinquent account, wherein the request includes a first input indicating a payment amount, a second input indicating a payment frequency, and a third input indicating a payment start date. The one or more processors may obtain account data associated with the delinquent account and determine, using a first model, a score for the delinquent account based on the first input, the second input, the third input, and the account data. The score may predict an ability to convert the delinquent account from a delinquent status to a current status. The one or more processors may determine, using a second model, a plurality of debt resolution plan parameters, for at least a first debt resolution plan and a second debt resolution plan, based on the score. The plurality of debt resolution plan parameters may include at least a first parameter indicating a repayment amount, a second parameter indicating a repayment frequency, and a third parameter indicating a repayment start date. At least one of the first debt resolution plan or the second debt resolution plan may include a restorative plan by which the delinquent account converts to the current status upon completion. The one or more processors may transmit the plurality of debt resolution plan parameters associated with the first debt resolution plan and the second debt resolution plan. The one or more processors may receive an enrollment request based on transmitting the plurality of debt resolution plan parameters, enroll the delinquent account in a selected debt resolution plan based on receiving the enrollment request, and cause an action to be performed based on enrolling the delinquent account in the selected debt resolution plan.

According to some possible implementations, a non-transitory computer-readable medium may store instructions that include one or more instructions that, when executed by one or more processors of a device, cause the one or more processors to receive a request for information regarding a debt resolution plan available for a delinquent account, wherein the request includes a first input indicating a payment amount, a second input indicating a payment frequency, and a third input indicating a payment start date. The one or more instructions may further cause the one or more processors to obtain account data associated with the delinquent account, and determine, using a first model, a score for the delinquent account based on the first input, the second input, the third input, and the account data. The score may predict an ability to convert the delinquent account from a delinquent status to a current status. The one or more instructions may further cause the one or more processors to determine, using a second model, a plurality of debt resolution plan parameters, for at least a first debt resolution plan and a second debt resolution plan, based on the score. The plurality of debt resolution plan parameters may include at least a first parameter indicating a repayment amount, a second parameter indicating a repayment frequency, and a third parameter indicating a repayment start date. The one or more instructions may further cause the one or more processors to transmit the plurality of debt resolution plan parameters associated with the first debt resolution plan and the second debt resolution plan, and receive an enrollment request based on transmitting the plurality of debt resolution plan parameters. The one or more instructions may further cause the one or more processors to enroll the delinquent account in a selected debt resolution plan based on receiving the enrollment request, and suspend a collection activity associated with the delinquent account based on enrolling the delinquent account in the selected debt resolution plan. The collection activity may include assigning a late fee to the delinquent account, assigning an interest amount to the delinquent account, or communicating a collection notice to a user associated with the delinquent account.

### BRIEF DESCRIPTION OF THE DRAWINGS

FIGS. 1A-1C are diagrams of an example implementation described herein.

FIGS. 2A-2H are diagrams of user interfaces associated with implementing debt resolution planning as described herein.

FIG. 3 is a diagram of an example environment in which devices, systems, and/or methods, described herein, may be implemented.

FIG. 4 is a diagram of example components of one or more devices of FIG. 3.

FIG. 5 is a flow chart of an example process for providing debt resolution planning.

FIG. 6 is a flow chart of an example process for providing debt resolution planning.

FIG. 7 is a flow chart of an example process for providing debt resolution planning.

### DETAILED DESCRIPTION

The following detailed description of example implementations refers to the accompanying drawings. The same reference numbers in different drawings may identify the same or similar elements.

Third-party credit counseling firms act as intermediaries on behalf of users, and broker debt settlements and/or debt management plans with the users' creditors. Existing debt management plans include terms set by the third-party credit counseling firms and the creditors and, thus, lack insight, intelligence, and/or user input. Moreover, existing debt management plans lack efficiency in terms of planning, enrolling, and/or allocating payments. For example, a user must often endure an undue wait time and, thus, incur unnecessary fees, before enrolling in a debt management plan, to allow a third-party credit counseling firm time to negotiate a payment, an interest rate, and/or a payment schedule with a creditor. Further, payments to a creditor may be delayed, as a user must make the payments directly to a third-party credit counseling firm, and then wait on the third-party credit counseling firm to disburse payments to the creditor. Existing practices associated with implementing existing debt management plans lend to inefficiencies, waste, fraud, and/or abuse in association with obtaining user information and/or allocating payments.

Some implementations described herein provide an interactive debt resolution planning platform, which obtains user inputs, obtains data for a user account, simulates future behavior associated with the user account, and intelligently matches the user and/or the user account to a plurality of debt resolution plans that the user may review and optionally enroll in. Upon receiving an enrollment request from a user, the debt resolution planning platform may automatically enroll the user account in a debt resolution plan so that the user may begin making payments directly to a creditor. In this way, delays associated with employing a third-party credit counseling firm may be obviated. As consideration for a user enrolling in a debt resolution plan, the debt management planning platform may automatically perform one or more actions that positively impact the user, such as suspending or reducing late fees from being applied to the user's debt, suspending or reducing interest from being applied to the user's debt, reducing a minimum payment for the user's debt, and/or suspending collection communications (e.g., collection calls, letters, emails, and/or the like) associated with the user's debt. In this way, a user may gain peace of mind that a debt may be positively resolved.

In this way, several different stages of a process for implementing intelligent debt resolution planning and/or enrollment may be automated, which may remove human subjectivity and waste from the process, and which may improve speed and efficiency of the process and conserve computing resources (e.g., processor resources, memory resources, and/or the like). Furthermore, implementations described herein employ a rigorous, computerized process to perform tasks or roles that were not previously performed or were previously performed using subjective human intuition or input. For example, currently there does not exist a technique for facilitating intelligent debt resolution planning and/or enrollment. Finally, automating the process for implementing intelligent debt resolution planning conserves computing resources (e.g., processor resources, memory resources, and/or the like) that would otherwise be wasted in attempting to negotiate and enroll a user in a debt management plan that may ultimately fail, due to a lack of intelligence, insight, and/or the like.

In this way, computing resources associated with a creditor (e.g., financial service provider, bank, etc.) that would otherwise be wasted in calculating fees, interest, sending out collection communications, and/or the like, may be minimized and/or conserved. Further, postal resources that would otherwise be wasted in mailing and/or shipping collection communications, late or delinquent notices, and/or the like, may be minimized and/or conserved. Further, computing and/or network resources associated with a user device, that would otherwise be wasted in receiving collection communications (e.g., e-mails, text messages, and/or the like) may be minimized and/or conserved. Finally, selecting and enrolling in a debt resolution plan provided by the debt resolution planning planform may improve a user's experience by placing the user more in control of the user's credit, to overcome what may feel like an otherwise helpless situation.

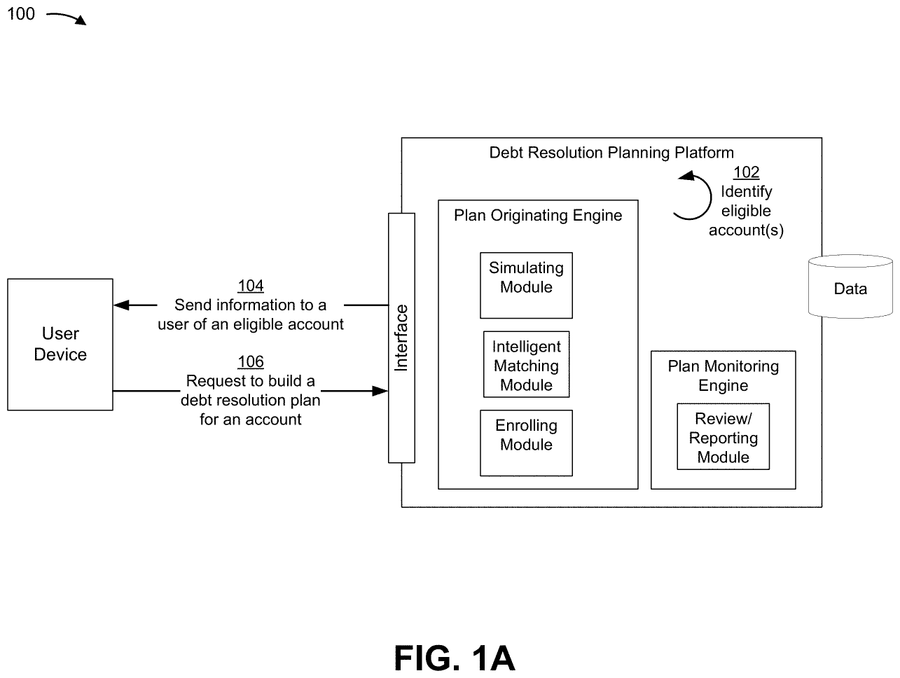

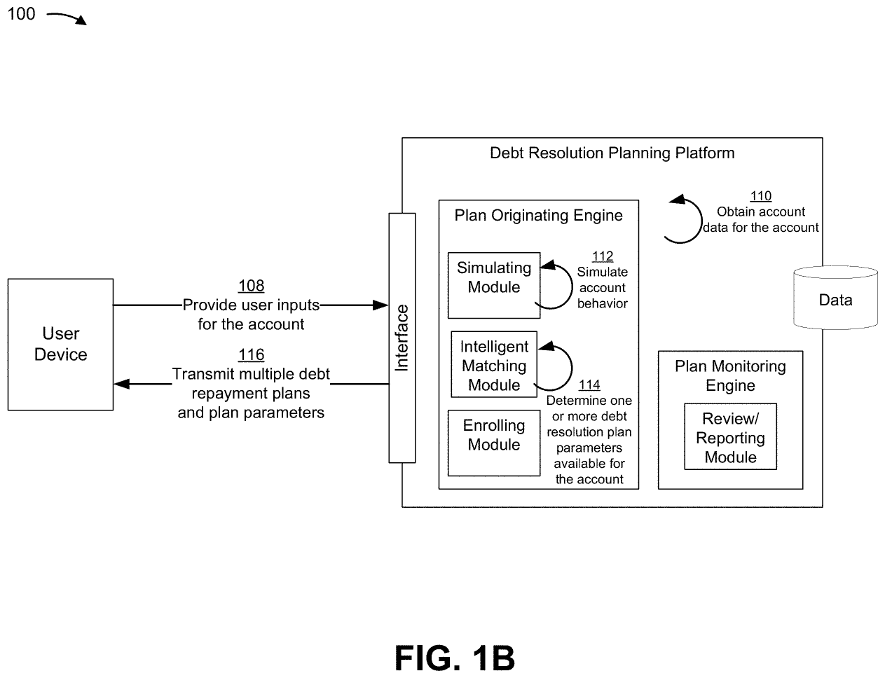

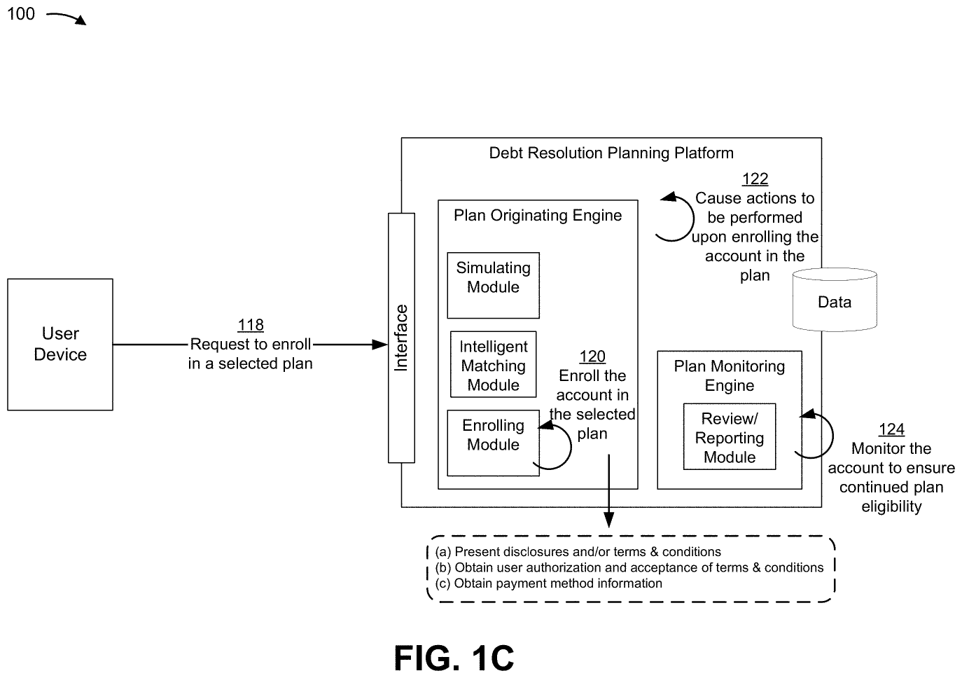

FIGS. 1A-1C are diagrams of an example implementation 100 described herein. As shown in FIGS. 1A-1C, example implementation 100 may include a debt resolution planning platform that interacts with one or more user devices. In some implementations, the debt resolution planning platform may include a plan originating engine, which may employ a simulating module and one or more models (e.g., algorithms, machine learning models, and/or the like) for simulating future activity and/or behavior associated with a user's account, an intelligent matching module and one or more models for applying intelligence and insight in determining debt resolution plans and/or plan parameters that best match the user's account, and an enrolling module for automating enrollment of the user's account in a debt resolution plan. Upon enrollment of the user account in a debt resolution plan, the debt resolution planning platform may cause various actions to be performed, automatically, that may suspend collection activities associated with the user's account. The debt resolution planning platform may additionally, or alternatively, include a plan monitoring engine, by which a user's compliance with a debt resolution plan may be reviewed and/or monitored.

In some implementations, the debt resolution planning platform may include an intelligent, digital planning tool, accessible to users (e.g., debtors, customers, account holders, and/or the like) having an account with a creditor (e.g., a business, a financial account provider, and/or the like), which the users may electronically access (e.g., by way of a wired network connection, a wireless network connection, and/or the like) to initiate an interactive debt resolution planning session. During the interactive debt resolution planning session, the debt resolution planning platform may obtain information from the user, by way of a user device, regarding the user's ability to pay a debt, obtain information regarding the user's account, and execute one or more models for simulating account behavior and/or determining one or more customized debt resolution plans to present to the user, by which the user may enroll to begin paying down a debt.

As shown in FIG. 1A, and by reference number 102, the debt resolution planning platform may identify one or more user accounts (e.g., credit card accounts, loan accounts, and/or the like) that are eligible for participation or enrollment in a debt resolution plan. As described herein, a debt resolution plan may include a restorative plan, by which a delinquent account may convert to a current status (e.g., as opposed to a delinquent status) upon completion, an accelerated charge off plan by which the delinquent account may be closed and reported to a credit entity (e.g., a credit bureau) as being charged off, and/or the like.

In some implementations, the debt resolution planning platform may obtain account information associated with a plurality of user accounts for a creditor, and flag eligible user accounts by way of assigning an electronic flag, tag, code, or status that identifies the user accounts as being eligible for enrollment in a debt resolution plan. As an example, the debt resolution planning platform may obtain account data or information including or indicating an amount of money owed by a user (e.g., an amount of a debt, a total amount owed to a creditor, an account balance, and/or the like), a user's payment history (e.g., a number of past payments, a number of missed payments, a date of a last payment, an amount of a last payment, and/or the like), a user's credit score, a user's credit limit, and/or the like. The debt resolution planning platform may identify a user account that is eligible for participation in a debt resolution plan, based on determining whether the account data satisfies a threshold. In this way, the debt resolution planning platform may notify users associated with the identified accounts of the ability to enroll in a debt resolution plan, to regain usage of an account, to more efficiently repay a debt, and/or the like.

For example, where a user's credit score satisfies a threshold, the debt resolution planning platform may identify the user's account as being eligible for participation in a debt resolution plan. Similarly, where a user's account balance satisfies a threshold, the debt resolution planning platform may identify the user's account as being eligible for participation in a debt resolution plan. Similarly, where a payment amount or a date of a last payment for a user's account is deficient and/or delinquent, the user's account may be identified as an eligible account. In some implementations, delinquent user accounts (e.g., accounts where a user has missed one or more payments) may be eligible for participation or enrollment in debt resolution plans. Such a debt resolution plan may allow a user to bring a delinquent user account up-to-date (e.g., cure the user account), so that the user account may be converted from a delinquent status (e.g., a status or flag assigned to an account by the debt resolution planning platform) to a current status, upon completion of the debt resolution plan. Additionally, or alternatively, such a debt resolution plan may allow a user to accelerate a charge off, of a user account, whereby the user account may be closed, and the debt may be repaid, as described herein. Allowing a user to pay off a debt that has been charged off, may allow the user to inhibit or avoid long-term damage to the user's credit score, as the debt resolution planning platform may automatically inform a credit entity that a charged off debt has been repaid, where a user satisfies a debt resolution plan to completion.

As further shown in FIG. 1A, and by reference number 104, the debt resolution planning platform may send information to a user of an eligible user account. In some implementations, the information may indicate, to the user, that the user account (e.g., identified by and/or associated with an account identifier) is delinquent, and eligible for participation or enrollment in a debt resolution plan. In some implementations, the information may additionally include an interactive link, whereby the user may obtain information for opting-in and/or enrolling the user account in a debt resolution plan by way of clicking on the link. In some implementations, the debt resolution planning platform may communicate the information, to the user, by way of a user device. The user device may include, for example, a computer (e.g., a laptop computer, a desktop computer, and/or the like), a tablet, a smart phone, a wearable computer (e.g., a smart watch, and/or the like), and/or the like.

As an example, the debt resolution planning platform may generate and send the user device a notification, a message, or an invitation, presenting the user with an opportunity to enroll an eligible user account in a debt resolution plan by way of the user device. The notification, message, or invitation may be communicated to the user device by way of electronic mail (e-mail), a Short Message Service (SMS) text message, a Multimedia Messaging Service (MMS) message, a letter (e.g., postal delivery), a telephone call, and/or the like. As another example, the debt resolution planning platform may notify the user by way of causing a pop-up window to display on the user's device, notifying the user that a user account is eligible for participating in a debt resolution plan.

As further shown in FIG. 1A, and by reference number 106, the user device may communicate, to the debt resolution planning platform, a request to establish (e.g., create, build, and/or the like) a debt resolution plan for a user account. The request may include an account identifier (e.g., an account number, a credit card number, a user identifier, and/or the) associated with the user account for which the debt resolution plan may be requested and implemented. In some implementations, the user may access and/or communicate with the debt resolution planning platform by way of a web-based portal or interface, a mobile application, and/or the like. In some implementations, the user device may communicate and/or interact with the debt resolution planning platform by way of a user interface, which may be configured to display information to the user, prompt the user to enter user inputs, and/or the like.

Turning now to FIG. 1B, and by reference number 108, one or more user inputs may be communicated to the debt resolution planning platform by way of the user device. Such user inputs may be used, for example, as data, input, and/or factors in determining one or more debt resolution plans and/or debt resolution plan parameters, as described herein. In some implementations, the debt resolution planning platform may prompt the user to enter one or more user inputs. For example, the debt resolution planning platform may prompt the user to enter a first input, indicating a payment amount that the user may be able to make in repaying a debt associated with the user account, a second input indicating a payment frequency (e.g., monthly, weekly, and/or the like) at which the user may make the payment amount, and a third input indicating a payment start date. In this way, the debt resolution planning platform may obtain the user inputs in a digital form, and utilize such user inputs to intelligently determine one or more debt resolution plans and/or debt resolution plan parameters to present to the user, by which the user may optionally enroll the user account.

As further shown in FIG. 1B, and by reference number 110, the debt resolution planning platform may obtain account data associated with the user account for which the debt resolution plan is requested. In some implementations, the debt resolution planning platform may access the account data for use in simulating future activity and/or behavior associated with the user account to determine, for example, whether the user account may charge off (e.g., become deemed uncollectable) in the future, whether the user account may be cured (e.g., transition from a delinquent status to a current, up-to-date status, and/or the like) in the future, and/or the like. As an example, the account data obtained by the debt resolution planning platform may include a current interest rate for a user account, a current amount of fees associated with the user account, a current minimum payment associated with the user account, information relating to a number of months to pay off a debt associated with the user account, information relating to past payments associated with the user account, and/or the like.

Additionally, or alternatively, and in some implementations, the account data obtained by the debt resolution planning platform may include a current balance for the user account, current and/or previous minimum payments for the user account, current and/or previous past due amounts for the user account, current, past, and/or upcoming cycle dates for the user account, upcoming due dates for payments associated with the user account, interest rates and/or interest rate terms for the user account, fees and/or fee terms for the user account, charge off terms for the user account, historical information indicating fees charged for the user account, historical information indicating payments associated with the user account, historical re-age information associated with the user account, and/or the like. Such data may be used to simulate future behavior of the user account and/or to determine debt resolution plan parameters, as described herein.

In some implementations, the debt resolution planning platform may obtain the account data from a data structure (e.g., a local or remote data structure), a system of record, and/or the like, accessible to the debt resolution planning platform. The account data may be obtained by way of a streaming service or interface, a subscription service, a batch monitoring service, an application programming interface (API), and/or the like. As a specific example, the debt resolution planning platform may obtain account data, including a current interest rate associated with a user account, a current account balance associated with the user account, and a date of a last payment associated with the user account that is eligible for enrollment in a debt resolution plan, by way of transmitting an API call to a service of record entity, and requesting the account data from the system of record entity (e.g., a system of record data structure).

As further shown in FIG. 1B, and by reference number 112, the debt resolution planning platform may simulate account activity and/or behavior based on the user inputs (i.e., obtained at 108) and/or the account data (i.e., obtained at 110) obtained by the debt resolution planning platform. In some implementations, the simulation may predict a likelihood of converting the user account from a delinquent status to a current status within a predetermined amount of time. In some implementations, the simulation may predict a likelihood that the user account may charge off during a predetermined amount of time. Such predictions may be based on one or more scores (e.g., one or more delinquency scores) determined during simulation of behavior for the user account. The predetermined amount of time used for the simulations may include a time period of about 60 months or less, about 48 months or less, about 36 months or less, about 24 months or less, or less than about 12 months. In some implementations, the debt resolution planning platform may predict one or more debt resolution plans and/or debt resolution plan parameters based on a result of simulating the behavior of the user account, as described herein.

In some implementations, the simulating module of the debt resolution planning platform may simulate the user account behavior using a model (e.g., a first model), such as an account simulating model or algorithm. The model may be used to determine one or more scores for the user account based on the first input, the second input, the third input, and/or the account data obtained by the debt resolution planning platform. Additional factors, inputs, and/or data may be included in the model, where desired, for simulating account behavior associated with the user account.

In some implementations, the model may include a machine learning model configured to receive, as input, the first input (e.g., the payment amount), the second input (e.g., the payment frequency), the third input (e.g., the payment start date), and/or account data (e.g., an interest rate for the user account, fees for the user account, minimum payment information for the user account, and/or the like), and determine, as output, the delinquency score based on performing a multi-source domain adaptation of historical data contained in a data structure. The model may be configured to correlate the historical data (e.g., historical user inputs, historical account data, and/or the like) to various domains or categories (e.g., account statuses (e.g., delinquency status, charge off status, current status, and/or the like)), and generate a plurality of scores for each domain or category. The delinquency score may include an aggregate or weighted score obtained by aggregating or weighting the plurality of scores determined by way of correlating the historical data to the various domains or categories. In this way, the model may intelligently simulate, or predict, future behavior for a user account based on historic account data and/or historic user inputs. In this way, the debt resolution planning platform may execute models for determining the delinquency score based on thousands, millions, and/or the like, of data points, thereby increasing an accuracy and consistency of the models. In this way, the debt resolution planning platform may analyze thousands, millions, or billions of data records for machine learning and model generation—a data set that cannot be processed objectively by a human actor.

In some implementations, the model may determine one or more delinquency scores, for a user account, which may indicate or predict an ability to convert the user account from the delinquent status to the current status during the predetermined amount of time. As an example, the delinquency score may include a value of between about 1 and 10, in which a lower delinquency score (e.g., 1 to 5, and/or the like) may indicate or predict a user account as being curable, whereas a higher delinquency score (e.g., 6-10, and/or the like) may indicate or predict a user account as being non-curable. Where the delinquency score is lower (e.g., compared to a threshold), a restorative debt resolution plan may be determined and presented to a user. Upon enrollment of a user account in a restorative debt resolution plan, the user may establish payments that may obviate the delinquency status associated with the user account and regain use of an account (e.g., a credit card account, and/or the like). As an example, the model may receive, as input, user inputs including a specified payment amount (e.g., $10.00), a specified frequency of payments (e.g., monthly payments), a specified payment start date, and account data, including payment history data (e.g., a number of late payments, and/or the like), and determine a delinquency score based on the inputs. In this case, for example, where the model receives inputs indicating a low payment amount and a large number of late payments for a user account, the delinquency score may be high. In this way, the debt resolution planning platform may intelligently predict account behavior, and determine debt resolution plans having plan parameters appropriate for a given user account, based on the account behavior and, thus, the delinquency score.

In some implementations, where the delinquency score is higher (e.g., compared to a threshold), an accelerated charge off plan may be determined and presented to the user. Upon enrollment of a user account in an accelerated charge off plan, the user account may be closed, automatically, and the user may establish a payment plan or schedule by which to off the debt and repair any damage to the user's credit score. In some implementations, a single delinquency score may be determined for a user account. Additionally, or alternatively, multiple delinquency scores may be determined for a user account. For example, multiple delinquency scores may be determined for multiple billing cycles associated with the user account. In this way, delinquency scores may be predicted over time, for multiple billing cycles. In this way, the accuracy of predicting account behavior may improve, over time.

In some implementations, the debt resolution planning platform may perform a training operation when generating the model to determine the delinquency scores. For example, the debt resolution planning platform may obtain historical data stored in a data structure, and portion the data into a training set, a validation set, a test set, and/or the like. In some implementations, the debt resolution planning platform may train the model to determine delinquency scores based on the historical data using, for example, an unsupervised training procedure based on the training set of data. For example, the debt resolution planning platform may perform a dimensionality reduction to reduce the training set of data to a minimum feature set, thereby reducing an amount of processing required to train the model to determine the delinquency scores, and may apply a classification technique, to the minimum feature set. The debt resolution planning platform may generate trained models using the minimum feature set to generate models based on thousands, millions, and/or the like of historic user inputs and historic account data for determining the delinquency scores associated with thousands, millions, and/or the like of accounts, thereby increasing an accuracy and consistency of the models. In this way, the debt resolution planning platform may analyze thousands, millions, or billions of data records for machine learning and model generation—a data set that cannot be processed objectively by a human actor.

As further shown in FIG. 1B, and by reference number 114, the debt resolution planning platform may determine one or more debt resolution plans and/or plan parameters for an account, based, at least in part, on the delinquency score. Where the delinquency score satisfies a first threshold, the debt resolution planning platform may determine a user account to be curable, and may automatically determine plan parameters associated with a restorative debt resolution plan, in which the user may enroll to begin making payments to bring the user account to a current status. Additionally, or alternatively, where the delinquency score satisfies a second threshold, the debt resolution planning platform may determine a user account to be non-curable, and may automatically determine plan parameters associated with accelerated charge off plan, in which the user may enroll to automatically close the user account and accelerate charge off of the user account. In this way, the debt resolution planning platform may intelligently predict behavior for individual user accounts, and customize one or more debt resolution plans for the user accounts based on the behavior. In this way, the debt resolution planning platform may conserve computing resources (e.g., processor resources, memory resources, and/or the like) that would otherwise be wasted in attempting to negotiate and enroll a user account in an arbitrary debt management plan that may ultimately fail, due to a lack of intelligence, insight, and/or the like. In some implementations, the debt resolution planning platform determines plan parameters for multiple debt resolution plans (e.g., at least a first and a second debt resolution plan), to present to a user. In this way, the user may play a role in determining which plan to enroll a user account.

Additionally, or alternatively, where the delinquency score satisfies a third threshold, the debt resolution planning platform may decline to automatically offer the user a debt resolution plan. For example, where the account may not be cured, may not charge off, and/or the like, the user may automatically be connected to an agent (e.g., a live agent, a chatbot, and/or the like), whereby the agent may automatically obtain a visual display of the user inputs (e.g., obtained at 108), and work directly with the user to determine an alternative debt resolution strategy.

In some implementations, the intelligent matching module of the debt resolution planning platform may determine the one or more debt resolution plan parameters using a model (e.g., a second model), such as intelligent plan determining and matching model or algorithm. The model may be used to determine plan parameters associated with one or more debt resolution plans. Such parameters may include at least a first parameter indicating a repayment amount for a debt resolution plan, a second parameter indicating a repayment frequency for the debt resolution plan, and a third parameter indicating a repayment start date for the debt resolution plan. The model may determine the plan parameters based on one or more inputs, including the delinquency score, the user inputs (e.g., obtained at 108), and/or the account data (e.g., obtained at 110), as described herein. Additional factors, inputs, and/or data may be included in the model, where desired, for determining debt resolution plan parameters. As an example, additional factors, inputs, and/or data may include historical data associated with previous debt resolution plans, a current account balance associated with a user account, a past due status associated with the user account, charging privileges associated with the user account, a product code (e.g., a type of account) associated with the user account, random numbers (e.g., for testing purposes), and/or the like.

In some implementations, the debt resolution planning platform may use a machine learning technique to generate the debt resolution plan parameters using the model. For example, the debt resolution planning platform may use collaborative filtering (e.g., user based collaborative filtering, account based collaborative filtering, and/or the like) to determine debt resolution plan parameters based on filtering the user inputs and/or the account data in view of historical data. The account data, input to the machine learning model, may provide data and insight associated with the user (e.g., the user's timeliness of making payments, the user's past payment history, and/or the like) and/or the user account (e.g., the current account balance, historical information on fees charged, historical information on interest, and/or the like). In this way, the data associated with the user and/or the user account may be used to intelligently determine the debt resolution plan parameter. The model may obtain historical data for past debt resolution plans, including past debt resolution plan parameters associated with a previous set of users and/or user accounts, and may use the historical data to determine current debt resolution plan parameters for a particular user. For example, where a user is prone to making late payments, the repayment amount and/or the payment frequency parameters may be optimized, based on the historical data available for users having a complementary payment history.

In some implementations, the debt resolution planning platform may perform a training operation when generating the model to determine the debt resolution plan parameters and match the user account to the debt resolution plan parameters. For example, the debt resolution planning platform may obtain the user inputs, account data, delinquency score, and/or historical data stored in a data structure, and portion the data into a training set, a validation set, a test set, and/or the like. In some implementations, the debt resolution planning platform may train the model to determine plan parameters based on the user inputs, account data, delinquency score, and/or historical data using, for example, an unsupervised training procedure based on the training set of data. For example, the debt resolution planning platform may perform dimensionality reduction to reduce the training set of data to a minimum feature set, thereby reducing an amount of processing required to train the model to determine the plan parameters, and may apply a classification technique, to the minimum feature set. The debt resolution planning platform may generate trained models using the minimum feature set to generate models based on thousands, millions, and/or the like of current and historic user inputs, current and/or historic account data, and/or the like, for determining the debt resolution plan parameters associated with thousands, millions, and/or the like of accounts, thereby increasing an accuracy and consistency of the models. In this way, the debt resolution planning platform may analyze thousands, millions, or billions of data records for machine learning and model generation—a data set that cannot be processed objectively by a human actor.

As further shown in FIG. 1B, and by reference number 116, the debt resolution planning platform may transmit multiple debt resolution plans, including multiple debt resolution plan parameters associated with the multiple debt resolution plans, to the user by way of the user device. The debt resolution planning platform may transmit the plan parameters, dynamically, by way of an interface (e.g., an interactive user interface, a communication interface, and/or the like). In some implementations, multiple sets of debt resolution plan parameters associated with multiple debt resolution plans may be transmitted to the user. In this way, the user may obtain multiple debt resolution plans that may be optimized and/or customized for the user and/or the user account, using intelligence derived from the account data, user inputs, and/or the like, as described above. In this way, the user may obtain, in real time (e.g., relative to requesting a plan), multiple debt resolution plans by which the user may optionally enroll to cure the user account, to charge off the user account, and/or the like. In this way, delays associated with obtaining, enrolling, implementing, and/or allocating payments for a debt resolution plan may be greatly reduced. In some implementations, the multiple debt resolution plans, and corresponding plan parameters, may be visually displayed to the user by way of the user device.

Turning now to FIG. 1C, and by reference number 118, the user may generate and send a request to enroll (e.g., opt in) the user account in a debt resolution plan, selected from the multiple debt resolution plans, determined by the debt resolution planning platform. In some implementations, the request may be generated and/or transmitted by the user device. For example, the user may interact with the debt resolution planning platform by way of one or more interactive links, web-based features, and/or the like, to select a debt resolution plan having desired debt resolution plan parameters, and request enrollment of the user account in the selected user plan. In some implementations, the user may interact with the debt resolution planning platform by way of a user interface disposed on the user device.

As further shown in FIG. 1C, and by reference number 120, the debt resolution planning platform may, automatically and/or in real time (e.g., relative to receiving a request to enroll), enroll the user account in the selected debt resolution plan. Upon enrolling the user account in the selected debt resolution plan, the debt resolution planning platform may automatically perform one or more actions. Such actions may include, for example, presenting, to the user, disclosures associated with enrolling in the selected debt resolution plan, presenting, to the user, terms and/or conditions associated with enrolling in the selected debt resolution plan, obtaining the user's authorization to enroll in the selected debt resolution plan, obtaining the user's acceptance of the terms and/or conditions associated with enrolling in the selected debt resolution plan, obtaining a payment method for paying a debt for the user account enrolled in the debt resolution plan, and/or combinations thereof, and/or the like. In this way, several different stages of a process for enrolling a user account in a selected debt resolution plan may be automated, which may remove human subjectivity, waste, and/or fraud from the process, and which may improve speed and efficiency of the process and conserve computing resources.

As further shown in FIG. 1C, and by reference number 122, the debt resolution planning platform may cause one or more actions to be performed based on enrolling the user account in the selected debt resolution plan. Such actions may include, for example, suspending or reducing late fees associated with the user account, suspending or reducing interest associated with the user account, reducing a minimum payment associated with the user account, suspending collection communications (e.g., collection e-mails, letters, telephone calls, and/or the like) associated with the user account, and/or the like. In this way, the user may receive one or more benefits (e.g., reduced fees, suspended interest, and/or the like) upon enrolling the user account in the selected debt resolution plan. In this way, the user may pay off a debt and optionally regain charging privileges for the user account, pay off a debt and minimize damage to a credit score, and/or the like.

Additionally, suspending collection communications may further conserve computing resources (e.g., of a creditor, a banking provider, a financial institute, and/or the like) that would otherwise be wasted determining late fees, accruing late fees, generating and sending out late notices associated with a delinquent account, reporting delinquency to a credit agency, performing collections activities, and/or the like. In this way, postal resources that would otherwise be wasted in processing and/or sending collection communications may be conserved. In this way, computing resources of a user device that would otherwise be wasted in receiving, processing, and/or accessing collection communications may be conserved. In turn, network resources that would otherwise be wasted in communicating collection notices may be conserved. In this way, the user may feel be in control of an otherwise helpless situation upon requesting, selecting, and/or enrolling in a debt resolution plan.

In some implementations, the debt resolution planning platform may automatically close a user account and inform a credit entity that the user account has charged off, where, for example, the user enrolls the user account in an accelerated charge off plan. Upon completing the accelerated charge off plan, the debt resolution planning platform may automatically inform the credit entity of the paid off debt, and the credit entity may be caused to reevaluate, and possibly increase, the user's credit score. In some implementations, the debt resolution planning platform may automatically generate and send an enrollment communication to the user. For example, the debt resolution planning platform may generate and send an e-mail communication to the user confirming enrollment of the user account in the selected debt resolution plan, a letter (e.g., postal delivery) to the user confirming enrollment of the user account in the selected debt resolution plan, a text message communication to the user confirming enrollment of the user account in the selected debt resolution plan, and/or the like.

As further shown in FIG. 1C, and by reference number 124, the debt resolution planning platform may monitor the user account, to ensure continued plan eligibility for the user account enrolled in the selected debt resolution plan. For example, the debt resolution planning platform may periodically review payment amounts associated with the user account enrolled in the debt resolution plan, payment dates associated with the user account enrolled in the debt resolution plan, and/or the like, to determine whether the user of the user account continues to satisfy and/or comply with the terms and/or conditions associated with the selected debt resolution plan, for which the user account is enrolled.

In some implementations, the debt resolution planning platform is configured to monitor activity associated with the selected debt resolution plan, detect completion of the selected debt resolution plan, and/or notify a credit entity that the user account is current or paid in full based on detecting completion of the selected debt resolution plan. In this way, the credit entity may be caused to reevaluate and/or increase a user's credit score, discontinue suppression of the user's credit score due to an unpaid debt, and/or the like. In some implementations, the debt resolution planning platform may be configured to monitor activity associated with the selected debt resolution plan, determine noncompliance with the selected debt resolution plan, and/or terminate the selected debt resolution plan. In this way, users that break, cancel, or fail to comply with the selected debt resolution plan may be discontinued from participating in the selected debt resolution plan (e.g. automatically disenrolled from the debt resolution plan), and optionally provided with an alternative recovery strategy.

In this way, users may request enrollment in and/or enroll in debt resolution plans, automatically, in relatively short amounts of time (e.g., less than 30 minutes, less than 10 minutes, less than 5 minutes, and/or the like), without having to experience delays associated with waiting on third-party credit counseling firms to negotiate with creditors, on behalf of the users. In this way, several different stages of a process for implementing intelligent debt resolution planning and/or enrollment may be automated, which may remove human subjectivity and waste from the process, and which may improve speed and efficiency of the process and conserve computing resources (e.g., processor resources, memory resources, and/or the like). Furthermore, implementations described herein employ a rigorous, computerized process to perform tasks or roles that were not previously performed or were previously performed using subjective human intuition or input. For example, currently there does not exist a technique for facilitating intelligent debt resolution planning and/or enrollment. Finally, automating the process for implementing intelligent debt resolution planning conserves computing resources (e.g., processor resources, memory resources, and/or the like) that would otherwise be wasted in attempting to negotiate and enroll a user in a debt management plan that may ultimately fail, due to a lack of intelligence, insight, and/or the like.

As indicated above, FIGS. 1A-1C are provided merely as an example. Other examples are possible and may differ from what is shown and described with regard to FIGS. 1A-1C.

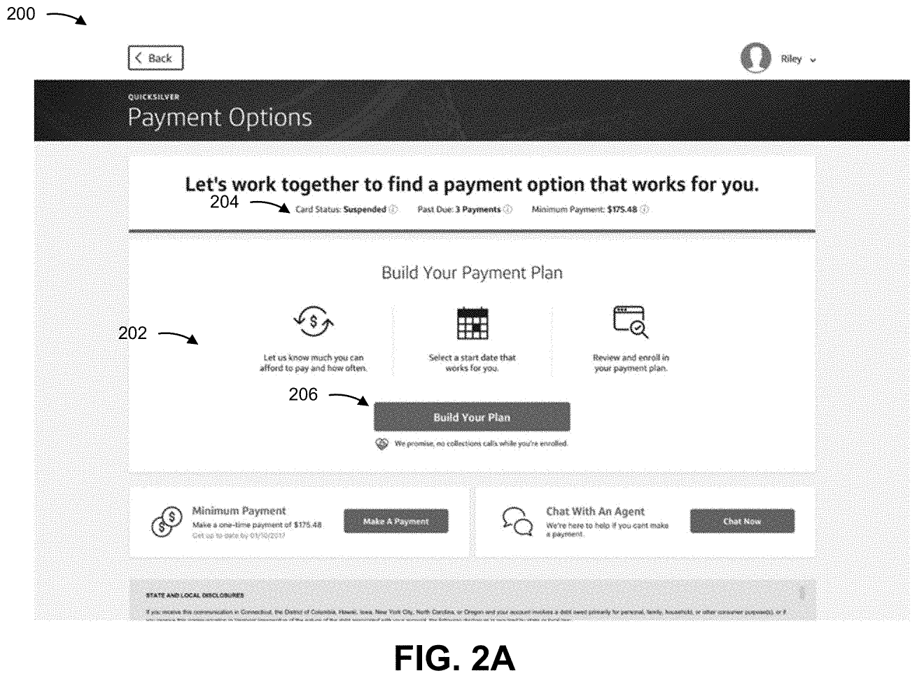

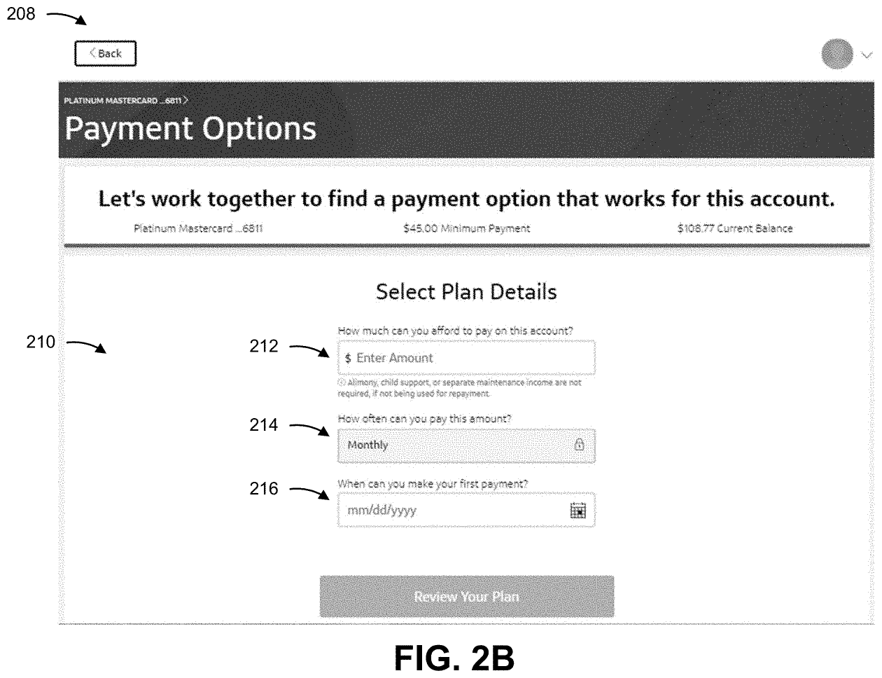

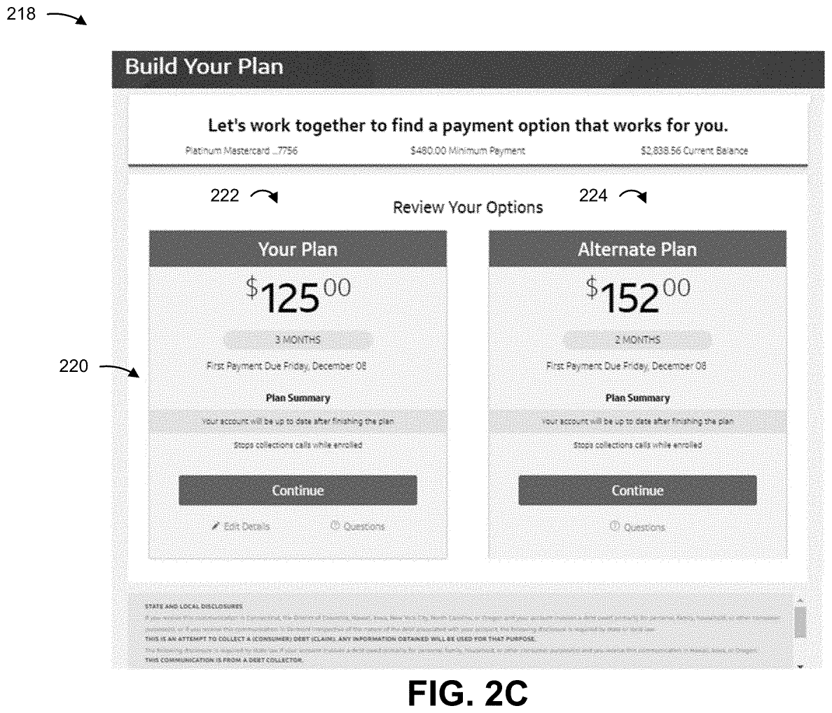

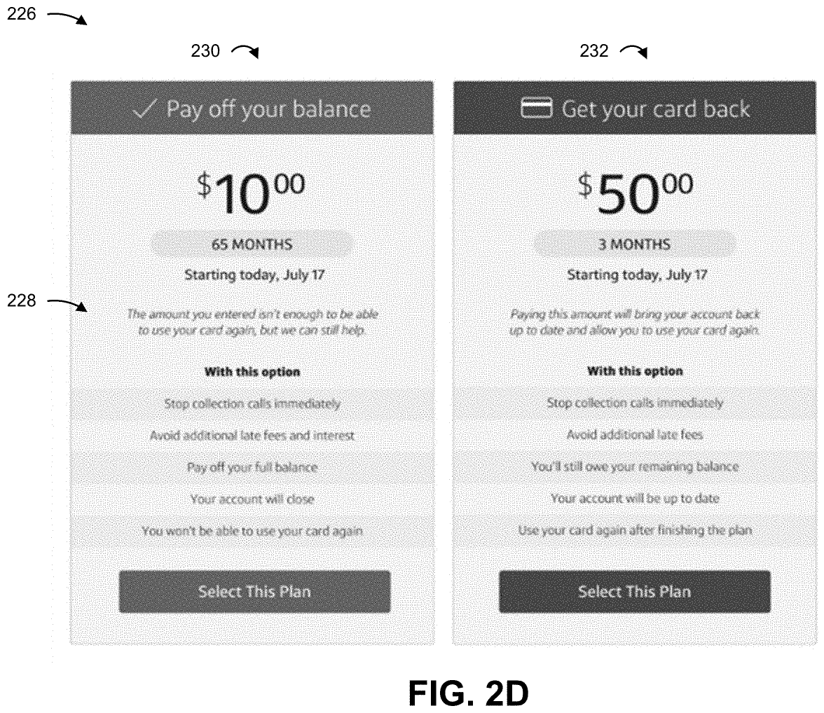

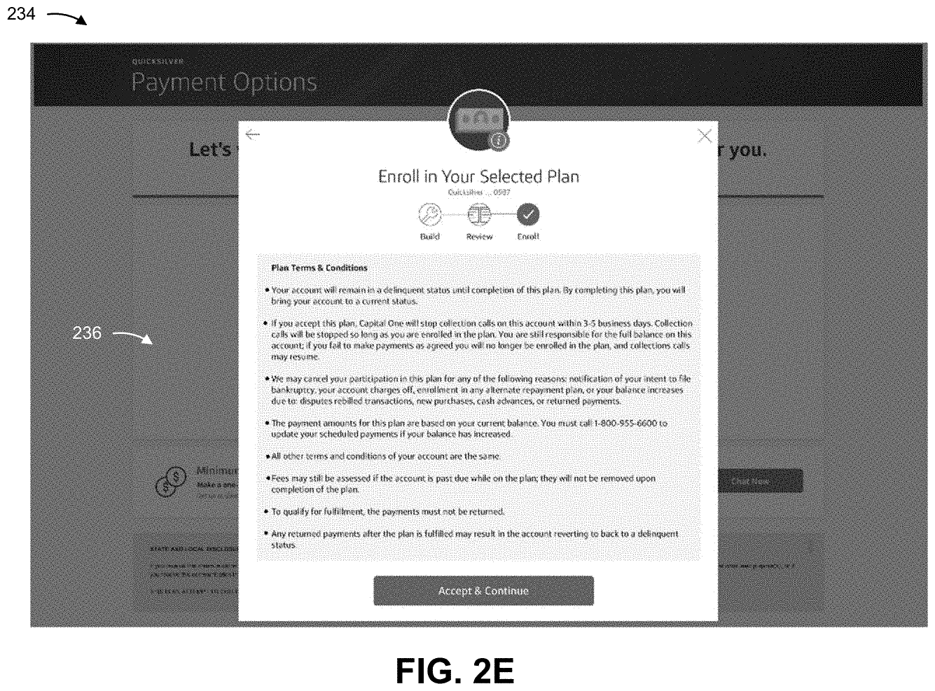

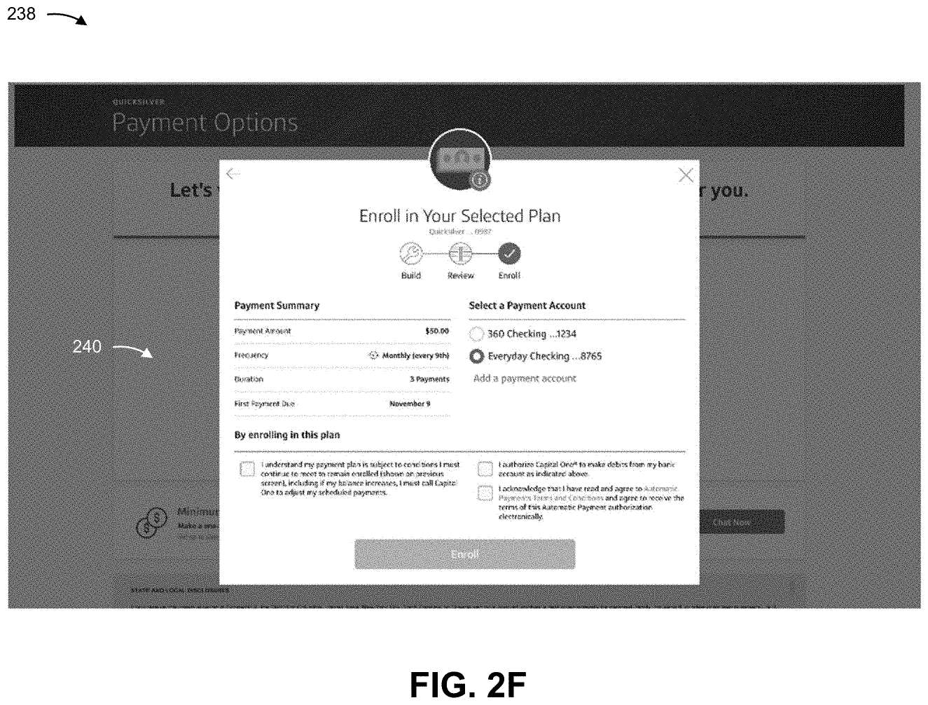

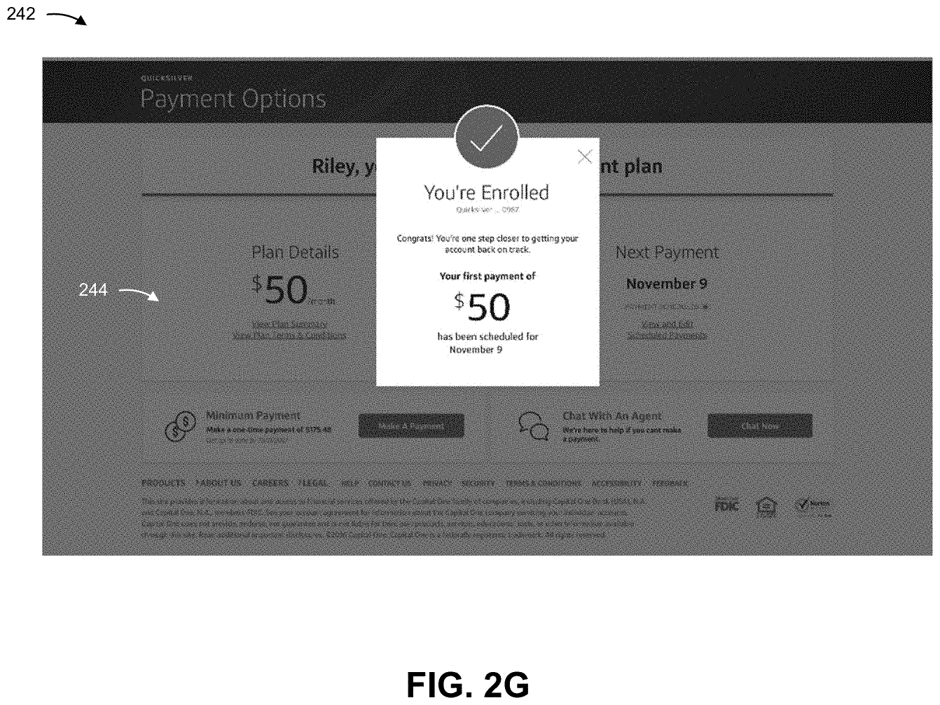

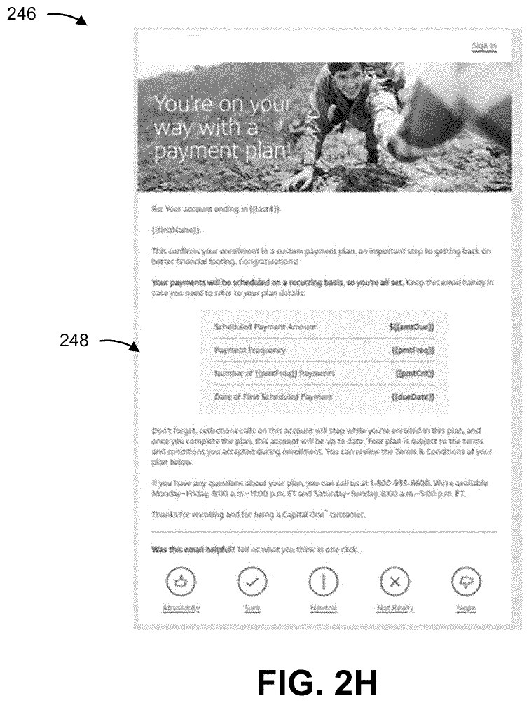

FIGS. 2A-2H are diagrams of user interfaces associated with implementing debt resolution planning as described herein.

Turning now to FIG. 2A, a first user interface view 200 of a first user interface 202 provided by a debt resolution planning platform is provided. First user interface 202 may offer a user an opportunity to enroll a user account in a debt resolution plan offered by a creditor. As first user interface 202 indicates by reference number 204, the user account may be suspended as a result of being past due (i.e., delinquent) by three payments, and include a minimum payment amount of $175.48. The payment amount of $175.48 may include an amount by which the account may transition from a delinquent status to a current status. For users unable to pay the full $175.48, the user may opt in to enrolling in a debt resolution plan, whereby the creditor may reduce the minimum payment, suspend or reduce interest being applied to the user account, suspend or reduce fees (e.g., late fees) being applied to the user account, and/or the like, in consideration for the user's participation in the debt resolution plan. The user may interact with the debt resolution planning platform, and initiate building of a debt resolution plan, by clicking one or more interactive links 206.

Turning now to FIG. 2B, a second user interface view 208 of a second user interface 210 of a debt resolution planning platform is provided. Second user interface 210 may prompt a user to enter one or more user inputs for use in determining a debt resolution plan and/or determining debt resolution plan parameters, as described above. As FIG. 2B illustrates, a user may enter a first input 212 corresponding to a payment amount that a user may be able to pay towards a balance of the user account, a second input 214 corresponding to a frequency at which the payment amount may be applied to the user account, and a third input 216 corresponding to a start date that the user may begin the debt resolution plan. The user may input such amounts by way of one or more interactive features (e.g., drop-down boxes, interactive calendars, interactive fields, and/or the like) provided and/or displayed by way of second user interface 210.

Turning now to FIG. 2C, a third user interface view 218 of a third user interface 220 of a debt resolution planning platform is provided. Third user interface 220 may display debt resolution plan parameters determined by the debt resolution planning platform, using one or more machine learning models or algorithms as described above, based on the user inputs and/or account data obtained by the debt resolution planning platform. In some implementations, the debt resolution planning platform may determine debt resolution plan parameters associated with at least a first debt resolution plan 222 and at least a second debt resolution plan 224. As FIG. 2C illustrates, each plan may include a first parameter indicating a repayment amount (e.g., $125.00 for first debt resolution plan 222, and $152.00 for second debt resolution plan 224), a second parameter indicating a repayment frequency (e.g., three months for first debt resolution plan 222, and two months for second debt resolution plan 224), and a third parameter indicating a repayment start date (e.g., December 8 for each of first debt resolution plan 222 and second debt resolution plan 224).

In some implementations, the debt resolution planning platform may determine and present, to the user, a basic plan (e.g., first debt resolution plan 222), by which the user may cure the user account over a longer time period, and the debt resolution planning platform may determine and present, to the user, an aspirational plan (e.g., second debt resolution plan 224), by which the user may cure the user account over an optimized, more efficient time period. Each of the first and second debt resolution plans may cause one or more actions to be performed, upon enrollment of the user account, in a respective one of the first and second debt resolution plans. For example, a collection activity (e.g., collection calls) may be suspended. Such collection calls may be suspended for one or more communication channels (e.g., telephone calls, texts, e-mails, mailed letters, and/or the like). The respective first and second debt resolution plans 222 and 224 may also cure the user's account, by transiting the account from a delinquent status to a current status upon finishing the plan. The user may also automatically select a plan, and request enrollment in the selected plan by clicking one or more interactive links associated with the debt resolution planning platform.

Turning now to FIG. 2D, a fourth user interface view 226 of a fourth user interface 228 of a debt resolution planning platform is provided. Fourth user interface 228 displays one or more additional debt resolution plan parameters, for one or more additional debt resolution plans, determined by the debt resolution planning platform, as described above, based on the user inputs and/or account data obtained by the debt resolution planning platform. In some implementations, the debt resolution planning platform may determine debt resolution plan parameters associated with at least a third debt resolution plan 230 and at least a fourth debt resolution plan 232. As FIG. 2D illustrates, each plan may include a first parameter indicating a repayment amount (e.g., $10.00 for third debt resolution plan 230, and $50.00 for fourth debt resolution plan 232), a second parameter indicating a repayment frequency (e.g., 65 months for third debt resolution plan 230, and three months for fourth debt resolution plan 232), and a third parameter indicating a repayment start date (e.g., July 17 for each of third debt resolution plan 230 and fourth debt resolution plan 232).

In some implementations, the debt resolution planning platform may determine an accelerated charge off plan (e.g., third debt resolution plan 230), by which the user account may be automatically closed, and the debt charged off. In some implementations, the accelerated charge off plan may be determined when a result of performing an account simulation determines that the user account will likely charge off in the future. When charging off a debt by way of an accelerated charge off plan, the debt resolution planning platform may automatically inform a credit entity that the account is closed, and that the debt is to be charged off, where, for example, a user selects the accelerated charge off plan. The user may avoid late fees, avoid interest, and relinquish charging privileges upon opting in to an accelerated charge off plan. Upon completion of the accelerated charge off plan, the debt resolution planning platform may automatically inform the credit entity that the charged off debt has been paid in full, so that the credit entity may reevaluate the user's credit score, allowing the user to begin rebuilding the user's credit score.

Additionally, or alternatively, the debt resolution planning platform may determine a restorative plan (e.g., fourth debt resolution plan 232), by which the delinquent account may be cured. The restorative plan may allow the user to avoid late fees and/or reduce minimum payments, while having the ability to restore charging privileges.

Turning now to FIG. 2E, a fifth user interface view 234 of a fifth user interface 236 of a debt resolution planning platform is provided. In some implementations, the debt resolution planning platform is configured to automatically display the terms and conditions associated with enrolling in a debt resolution plan to a user by way of the fifth user interface 236. Example debt resolution terms and/or conditions may include or specify the actions that may occur upon completion of the debt resolution plan (e.g., account restored to a current status), actions that may occur upon enrolling in the plan (e.g., suspending collection activities), and/or the like.

Turning now to FIG. 2F, a sixth user interface view 238 of a sixth user interface 240 of a debt resolution planning platform is provided. In some implementations, the debt resolution planning platform may be configured to automatically acquire payment information and/or establish a payment method associated with making payments for a debt resolution plan. As sixth user interface 240 illustrates, the user may select a debt resolution plan, and specify a payment method for making payments towards a balance of the user account enrolled in the debt resolution plan, by way of entering an account identifier (e.g., a credit card account identifier, a checking account identifier, a debit card account identifier, and/or the like).

Turning now to FIG. 2G, a seventh user interface view 242 of a seventh user interface 244 of a debt resolution planning platform is provided. In some implementations, the user may review parameters associated with a debt resolution plan, select a debt resolution plan, review the terms and/or conditions associated with the selected debt resolution plan, optionally provide payment information for making payments towards a debt while enrolled in the debt resolution plan, and automatically opt in to enrollment in the selected plan by way of seventh user interface 244. The entire process for determining and enrolling in a debt resolution plan may be streamlined and/or automated. In this way, computing resources and/or network resources that would otherwise be wasted in attempting to negotiate and enroll a user in a debt management plan that may ultimately fail, due to a lack of intelligence, insight, and/or the like, may be conserved.

Turning now to FIG. 2H, an eighth user interface view 246 of an eighth user interface 248 of a debt resolution planning platform is provided. In some implementations, the debt resolution planning platform may generate and send an enrollment communication to the user upon enrolling in a selected debt resolution plan. Eighth user interface 248 illustrates an example enrollment communication. As FIG. 2H illustrates, the enrollment communication may include a summary of the terms and/or conditions associated with a selected debt resolution plan, an overview or summary of plan parameters for the selected debt resolution plan, and/or the like.

It will be understood that FIGS. 2A-2H are provided merely as examples. Other examples are possible and may differ from what is shown and described with regard to FIGS. 2A-2H.

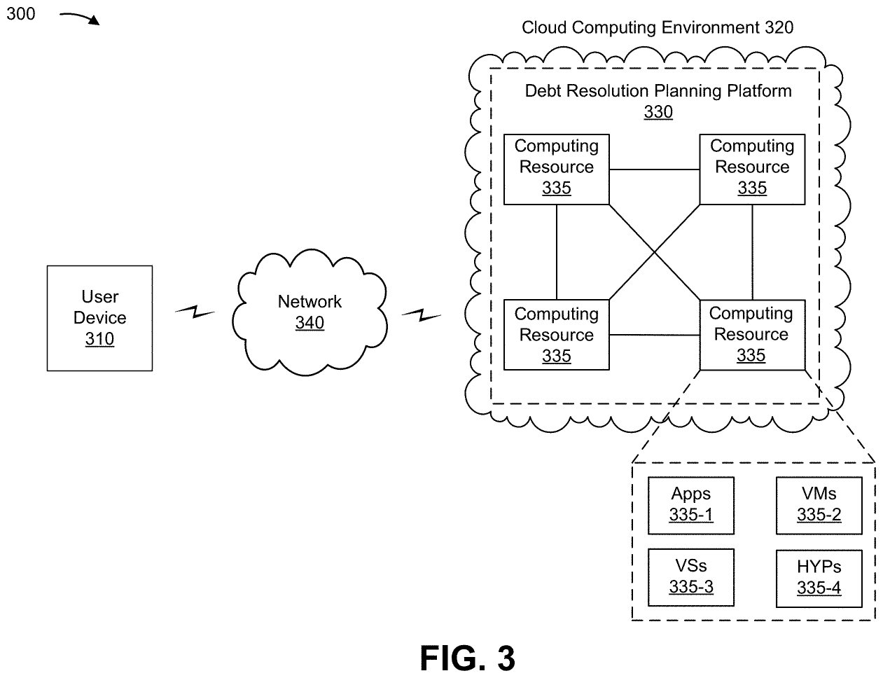

FIG. 3 is a diagram of an example environment 300 in which devices, systems, and/or methods, described herein, may be implemented. As shown in FIG. 3, environment 300 may include one or more user devices 310, a cloud computing environment 320, a debt resolution planning platform 330, and one or more computing resources 335. Devices of environment 300 may interconnect via wired connections, wireless connections, or a combination of wired and wireless connections.

User device 310 may include one or more devices capable of receiving, generating, storing, processing, and/or providing information associated with facilitating debt resolution planning, whereby a user, may obtain, select, and enroll in a debt resolution plan by way of user device 310. For example, user device 310 may include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device.

Cloud computing environment 320 may include an environment that delivers computing as a service, whereby shared resources, services, etc., may be provided to debt resolution planning platform 330 for use in providing intelligent, customizable debt resolution planning. Cloud computing environment 320 may provide computation, software, data access, storage, and/or other services that do not require end-user knowledge of a physical location and configuration of a system and/or a device that delivers the services. As shown, cloud computing environment 320 may include debt resolution planning platform 330 and one or more computing resources 335.

Debt resolution planning platform 330 may include one or more devices capable of receiving, generating, storing, processing, and/or providing information associated with facilitating debt resolution planning, whereby a user may obtain, select, and/or enroll in a debt resolution plan by way of user device 310. While the example environment 300 indicates that debt resolution planning platform 330 as being implemented in a cloud computing environment 320, in some implementations, debt resolution planning platform 330 may be implemented by one or more other types of devices as well, such as a server, computer, laptop computer, tablet computer, handheld computer, or the like. Debt resolution planning platform 330 is capable of obtaining data provided by a user of user device 310 to intelligently determine, implement, schedule, and/or plan a customized debt resolution plan for a user. Debt resolution planning platform 330 may, in some implementations, include, or otherwise have access to other resources, that facilitate the intelligent determination, implementation, scheduling, and/or planning debt resolution plans by way of executing models based on machine learning, historical data, and/or the like.

Computing resource 335 may include one or more personal computers, workstation computers, server devices, or another type of computation and/or communication device. In some implementations, computing resource 335 may host debt resolution planning platform 330. The cloud resources may include compute instances executing in computing resource 335, storage devices provided in computing resource 335, data transfer devices provided by computing resource 335, and/or the like. In some implementations, computing resource 335 may communicate with other computing resources 335 by way of wired connections, wireless connections, or a combination of wired and wireless connections.

As further shown in FIG. 3, computing resource 335 may include a group of cloud resources, such as one or more applications (“APPs”) 335-1, one or more virtual machines (“VMs”) 335-2, virtualized storage (“VSs”) 335-3, one or more hypervisors (“HYPs”) 335-4, and/or the like.

Application 335-1 may include one or more software applications that may be provided to or accessed by user device 310. Application 335-1 may eliminate a need to install and execute the software applications on user device 310. For example, application 335-1 may include software associated with debt resolution planning platform 330 and/or any other software capable of being provided via cloud computing environment 320. In some implementations, one application 335-1 may send/receive information to/from one or more other applications 335-1, via virtual machine 335-2.

Virtual machine 335-2 may include a software implementation of a machine (e.g., a computer) that executes programs like a physical machine. Virtual machine 335-2 may be either a system virtual machine or a process virtual machine, depending upon use and degree of correspondence to any real machine by virtual machine 335-2. A system virtual machine may provide a complete system platform that supports execution of a complete operating system (“OS”). A process virtual machine may execute a single program and may support a single process. In some implementations, virtual machine 335-2 may execute on behalf of a user (e.g., of user device 310, debt resolution planning platform 330, and/or the like), and/or may manage infrastructure of cloud computing environment 320, such as data management, synchronization, or long-duration data transfers.

Virtualized storage 335-3 may include one or more storage systems and/or one or more devices that use virtualization techniques within the storage systems or devices of computing resource 335. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 335-4 provides hardware virtualization techniques that allow multiple operating systems (e.g., “guest operating systems”) to execute concurrently on a host computer, such as computing resource 335. Hypervisor 335-4 may present a virtual operating platform to the guest operating systems, and may manage the execution of the guest operating systems. Multiple instances of a variety of operating systems may share virtualized hardware resources.

Network 340 may include one or more wired and/or wireless networks. For example, network 340 may include a cellular network (e.g., a long-term evolution (LTE) network, a code division multiple access (CDMA) network, a 3G network, a 4G network, a 5G network, another type of next generation network, etc.), a communication network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

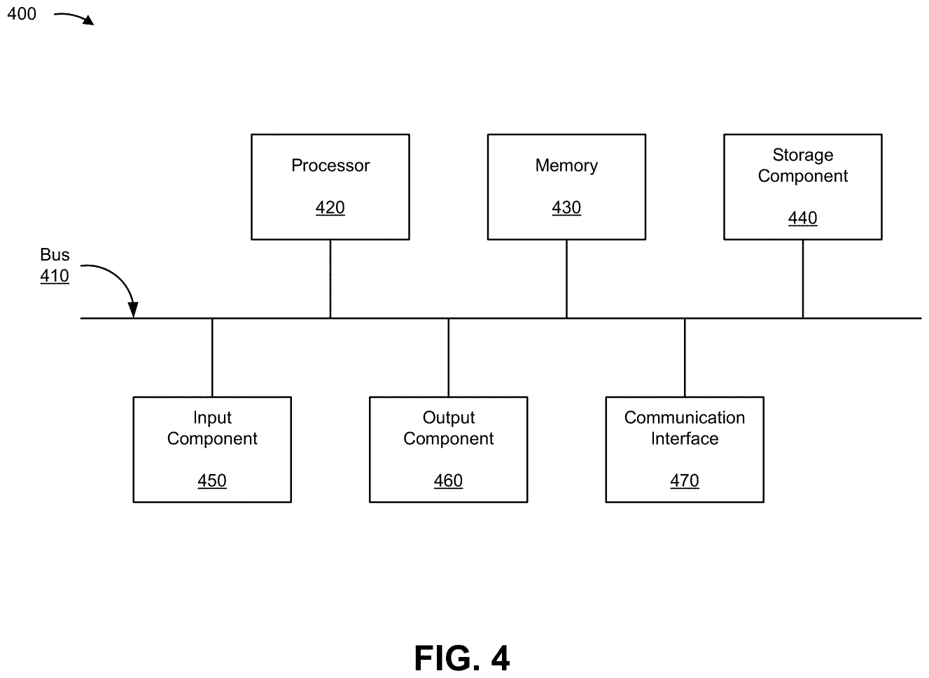

FIG. 4 is a diagram of example components of a device 400. Device 400 may correspond to user device 310, debt resolution planning platform 330, and/or computing resource 335 of debt resolution planning platform 330. In some implementations, user device 310, debt resolution planning platform 330, and/or computing resource 335 of debt resolution planning platform 330 may include one or more devices 400 and/or one or more components of device 400. As shown in FIG. 4, device 400 may include a bus 410, a processor 420, a memory 430, a storage component 440, an input component 450, an output component 460, and a communication interface 470.

Bus 410 may include a component that permits communication among the components of device 400. Processor 420 may be implemented in hardware, firmware, or a combination of hardware and software. Processor 420 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 420 includes one or more processors capable of being programmed to perform a function. Memory 430 may include a random-access memory (RAM), a read only memory (ROM), and/or another type of dynamic or static storage device (e.g., a flash memory, a magnetic memory, and/or an optical memory) that stores information and/or instructions for use by processor 420.

Storage component 440 may store information and/or software related to the operation and use of device 400. For example, storage component 440 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 450 may include a component that permits device 400 to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 may include a component that provides output information from device 400 (e.g., a display, a speaker, and/or one or more light-emitting diodes (LEDs)).

Communication interface 470 may include a transceiver-like component (e.g., a transceiver and/or a separate receiver and transmitter) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, and/or the like.

Device 400 may perform one or more processes described herein. Device 400 may perform these processes based on processor 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

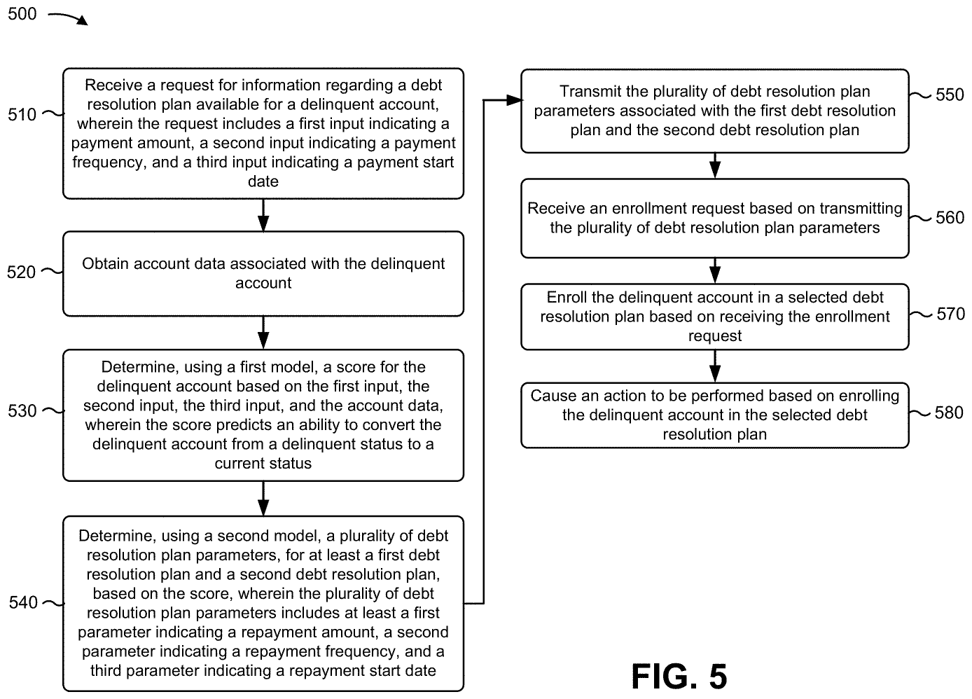

FIG. 5 is a flow chart of an example process 500 for providing debt resolution planning. In some implementations, one or more process blocks of FIG. 5 may be performed by a debt resolution planning platform (e.g., debt resolution planning platform 330). In some implementations, one or more process blocks of FIG. 5 may be performed by another device or a group of devices separate from or including the debt resolution planning platform 330, such as user device 310. In some implementations, one or more process blocks of FIG. 5 may be performed by a cloud computing resource (e.g., computing resources 335) of cloud computing environment 320.

As shown in FIG. 5, process 500 may include receiving a request for information regarding a debt resolution plan available for a delinquent account, wherein the request includes a first input indicating a payment amount, a second input indicating a payment frequency, and a third input indicating a payment start date (block 510). For example, the debt resolution planning platform (e.g., using memory 430, storage component 440, input component 450, communication interface 470, and/or the like) may receive a request for information regarding a debt resolution plan available for a delinquent account, as described above in FIGS. 1A-1C. In some implementations, the request includes a first input indicating a payment amount, a second input indicating a payment frequency, and a third input indicating a payment start date.

As further shown in FIG. 5, process 500 may include obtaining account data associated with the delinquent account (block 520). For example, the debt resolution planning platform (e.g., using memory 430, storage component 440, input component 450, communication interface 470, and/or the like) may obtain account data associated with the delinquent account, as described above in FIGS. 1A-1C.

As further shown in FIG. 5, process 500 may include determining, using a first model, a score for the delinquent account based on the first input, the second input, the third input, and the account data, wherein the score predicts an ability to convert the delinquent account from a delinquent status to a current status (block 530). For example, the debt resolution planning platform (e.g., using processor 420, memory 430, storage component 440, communication interface 470, and/or the like) may determine a score for the delinquent account based on the first input, the second input, the third input, and the account data, as described above in FIGS. 1A-1C. In some implementations, the score predicts an ability to convert the delinquent account from a delinquent status to a current status.

As further shown in FIG. 5, process 500 may include determining, using a second model, a plurality of debt resolution plan parameters for at least a first debt resolution plan and a second debt resolution plan, based on the score, wherein the plurality of debt resolution plan parameters includes at least a first parameter indicating a repayment amount, a second parameter indicating a repayment frequency, and a third parameter indicating a repayment start date (block 540). For example, debt resolution planning platform (e.g., using processor 420, memory 430, storage component 440, communication interface 470, and/or the like) may determine a plurality of debt resolution plan parameters for at least a first debt resolution plan and a second debt resolution plan, based on the score, as described above in FIGS. 1A-1C. In some implementations, the plurality of debt resolution plan parameters includes at least a first parameter indicating a repayment amount, a second parameter indicating a repayment frequency, and a third parameter indicating a repayment start date.

As further shown in FIG. 5, process 500 may include transmitting the plurality of debt resolution plan parameters associated with the first debt resolution plan and the second debt resolution plan (block 550). For example, debt resolution planning platform (e.g., using storage component 440, output component 460, communication interface 470, and/or the like) may transmit the plurality of debt resolution plan parameters associated with the first debt resolution plan and the second debt resolution plan, as described above in FIGS. 1A-1C.

As further shown in FIG. 5, process 500 may include receiving an enrollment request based on transmitting the plurality of debt resolution plan parameters (block 560). For example, debt resolution planning platform (e.g., using storage component 440, input component 450, communication interface 470, and/or the like) may receive an enrollment request based on transmitting the plurality of debt resolution plan parameters, as described above in FIGS. 1A-1C.

As further shown in FIG. 5, process 500 may include enrolling the delinquent account in a selected debt resolution plan based on receiving the enrollment request (block 570). For example, debt resolution planning platform (e.g., using processor 420, memory 430, storage component 440, communication interface 470, and/or the like) may enroll the delinquent account in a selected debt resolution plan based on receiving the enrollment request, as described above in FIGS. 1A-1C.

As further shown in FIG. 5, process 500 may include causing an action to be performed based on enrolling the delinquent account in the selected debt resolution plan (block 580). For example, debt resolution planning platform (e.g., using processor 420, memory 430, storage component 440, input component 450, output component 460, communication interface 470, and/or the like) may cause an action to be performed based on enrolling the delinquent account in the selected debt resolution plan, as described above in FIGS. 1A-1C.

Process 500 may include additional implementations, such as any single implementation or any combination of implementations described below and/or in connection with one or more other processes described elsewhere herein.

In some implementations, process 500 includes determining the first debt resolution plan and the second debt resolution plan, wherein at least one of the first debt resolution plan or the second debt resolution plan includes a restorative plan by which the delinquent account converts to the current status upon completion. In some implementations, at least one of the first debt resolution plan or the second debt resolution plan includes an accelerated charge off plan by which the delinquent account is closed.

In some implementations, process 500 includes performing an action including suspending or reducing late fees for the delinquent account, suspending, or reducing interest for the delinquent account, reducing a minimum payment for the delinquent account, or suspending collection communications for the delinquent account. In some implementations, process 500 includes monitoring activity associated with the selected debt resolution plan, detecting completion of the selected debt resolution plan, and notifying a credit entity that the delinquent account is current or paid in full based on detecting completion of the selected debt resolution plan. In some implementations, process 500 includes monitoring activity associated with the selected debt resolution plan, determining noncompliance with the selected debt resolution plan, and terminating the selected debt resolution plan.

In some implementations, process 500 includes obtaining account data such as a current interest rate for the delinquent account, a current amount of fees associated with the delinquent account, or a current minimum payment associated with the delinquent account. In some implementations, the delinquent account includes a credit card account or a loan account.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

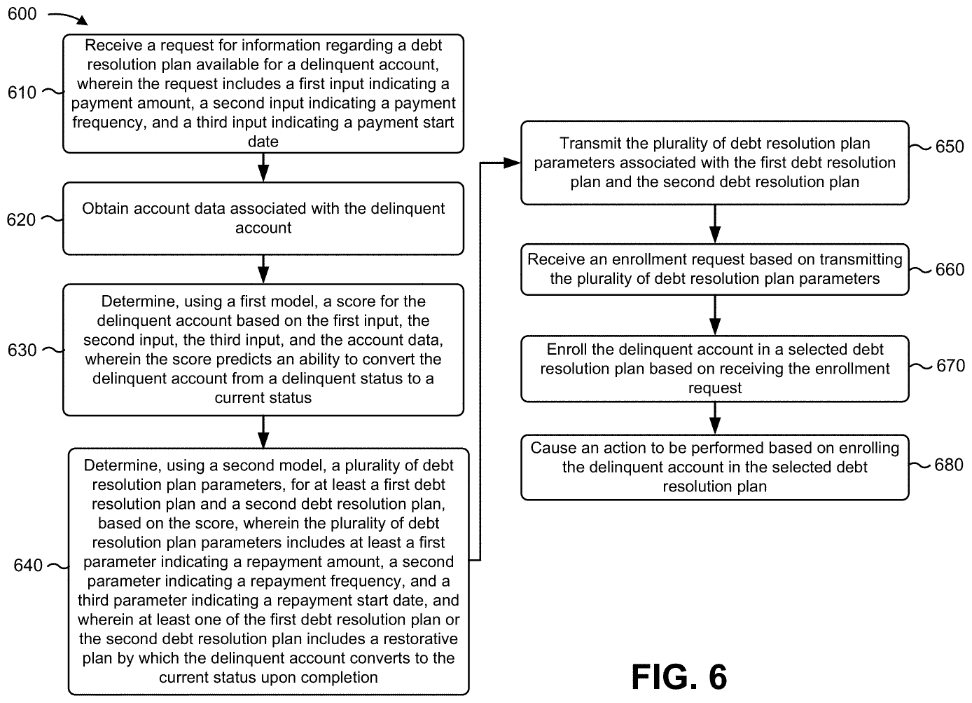

FIG. 6 is a flow chart of an example process 600 for providing debt resolution planning. In some implementations, one or more process blocks of FIG. 6 may be performed by a debt resolution planning platform (e.g., debt resolution planning platform 330). In some implementations, one or more process blocks of FIG. 6 may be performed by another device or a group of devices separate from or including the debt resolution planning platform 330, such as user device 310. In some implementations, one or more process blocks of FIG. 6 may be performed by a cloud computing resource (e.g., computing resources 335) of cloud computing environment 320.

As shown in FIG. 6, process 600 may include receiving a request for information regarding a debt resolution plan available for a delinquent account, wherein the request includes a first input indicating a payment amount, a second input indicating a payment frequency, and a third input indicating a payment start date (block 610). For example, the debt resolution planning platform (e.g., using memory 430, storage component 440, input component 450, communication interface 470, and/or the like) may receive a request for information regarding a debt resolution plan available for a delinquent account, as described above in FIGS. 1A-1C. In some implementations, the request includes a first input indicating a payment amount, a second input indicating a payment frequency, and a third input indicating a payment start date.

As further shown in FIG. 6, process 600 may include obtaining account data associated with the delinquent account (block 620). For example, the debt resolution planning platform (e.g., using memory 430, storage component 440, input component 450, communication interface 470, and/or the like) may obtain account data associated with the delinquent account, as described above in FIGS. 1A-1C.

As further shown in FIG. 6, process 600 may include determining, using a first model, a score for the delinquent account based on the first input, the second input, the third input, and the account data, wherein the score predicts an ability to convert the delinquent account from a delinquent status to a current status (block 630). For example, the debt resolution planning platform (e.g., using processor 420, memory 430, storage component 440, communication interface 470, and/or the like) may determine a score for the delinquent account based on the first input, the second input, the third input, and the account data, as described above in FIGS. 1A-1C. In some implementations, the score predicts an ability to convert the delinquent account from a delinquent status to a current status.

As further shown in FIG. 6, process 600 may include determining, using a second model, a plurality of debt resolution plan parameters for at least a first debt resolution plan and a second debt resolution plan, based on the score, wherein the plurality of debt resolution plan parameters includes at least a first parameter indicating a repayment amount, a second parameter indicating a repayment frequency, and a third parameter indicating a repayment start date, and wherein at least one of the first debt resolution plan or the second debt resolution plan includes a restorative plan by which the delinquent account converts to the current status upon completion (block 640). For example, debt resolution planning platform (e.g., using processor 420, memory 430, storage component 440, communication interface 470, and/or the like) may determine a plurality of debt resolution plan parameters for at least a first debt resolution plan and a second debt resolution plan, based on the score, as described above in FIGS. 1A-1C. In some implementations, the plurality of debt resolution plan parameters includes at least a first parameter indicating a repayment amount, a second parameter indicating a repayment frequency, and a third parameter indicating a repayment start date. In some implementations, the at least one of the first debt resolution plan or the second debt resolution plan includes a restorative plan by which the delinquent account converts to the current status upon completion.

As further shown in FIG. 6, process 600 may include transmitting the plurality of debt resolution plan parameters associated with the first debt resolution plan and the second debt resolution plan (block 650). For example, debt resolution planning platform (e.g., using storage component 440, output component 460, communication interface 470, and/or the like) may transmit the plurality of debt resolution plan parameters associated with the first debt resolution plan and the second debt resolution plan, as described above in FIGS. 1A-1C.

As further shown in FIG. 6, process 600 may include receiving an enrollment request based on transmitting the plurality of debt resolution plan parameters (block 660). For example, debt resolution planning platform (e.g., using storage component 440, input component 450, communication interface 470, and/or the like) may receive an enrollment request based on transmitting the plurality of debt resolution plan parameters, as described above in FIGS. 1A-1C.

As further shown in FIG. 6, process 600 may include enrolling the delinquent account in a selected debt resolution plan based on receiving the enrollment request (block 670). For example, debt resolution planning platform (e.g., using processor 420, memory 430, storage component 440, communication interface 470, and/or the like) may enroll the delinquent account in a selected debt resolution plan based on receiving the enrollment request, as described above in FIGS. 1A-1C.

As further shown in FIG. 6, process 600 may include causing an action to be performed based on enrolling the delinquent account in the selected debt resolution plan (block 680). For example, debt resolution planning platform (e.g., using processor 420, memory 430, storage component 440, input component 450, output component 460, communication interface 470, and/or the like) may cause an action to be performed based on enrolling the delinquent account in the selected debt resolution plan, as described above in FIGS. 1A-1C.

Process 600 may include additional implementations, such as any single implementation or any combination of implementations described below and/or in connection with one or more other processes described elsewhere herein.

In some implementations, process 600 includes causing an action to be performed, where the action includes suspending or reducing late fees for the delinquent account, suspending or reducing interest for the delinquent account, reducing a minimum payment for the delinquent account, or suspending collection communications for the delinquent account. In some implementations, the collection communications include communications delivered by way of electronic mail, telephone, and/or a postal service.

In some implementations, process 600 includes monitoring activity associated with the selected debt resolution plan, detecting completion of the selected debt resolution plan, and notifying a credit entity that the delinquent account is current or paid in full based on detecting completion of the selected debt resolution plan. In some implementations, process 600 includes monitoring activity associated with the selected debt resolution plan, determining noncompliance with the selected debt resolution plan, and terminating the selected debt resolution plan.

In some implementations, process 600 includes receiving the request from a computing device. In some implementations, process 600 includes generating and sending an enrollment communication to the user.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

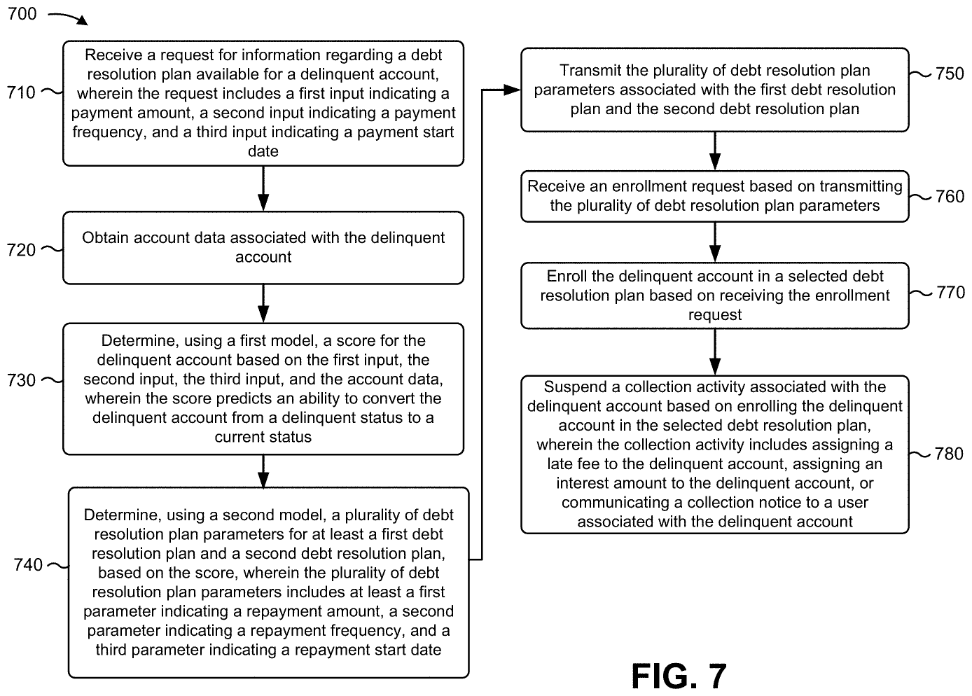

FIG. 7 is a flow chart of an example process 700 for providing debt resolution planning. In some implementations, one or more process blocks of FIG. 7 may be performed by a debt resolution planning platform (e.g., debt resolution planning platform 330). In some implementations, one or more process blocks of FIG. 7 may be performed by another device or a group of devices separate from or including the debt resolution planning platform 330, such as user device 310. In some implementations, one or more process blocks of FIG. 7 may be performed by a cloud computing resource (e.g., computing resources 335) of cloud computing environment 320.

As shown in FIG. 7, process 700 may include receiving a request for information regarding a debt resolution plan available for a delinquent account, wherein the request includes a first input indicating a payment amount, a second input indicating a payment frequency, and a third input indicating a payment start date (block 710). For example, the debt resolution planning platform (e.g., using memory 430, storage component 440, input component 450, communication interface 470, and/or the like) may receive a request for information regarding a debt resolution plan available for a delinquent account, as described above in FIGS. 1A-1C. In some implementations, the request includes a first input indicating a payment amount, a second input indicating a payment frequency, and a third input indicating a payment start date.

As further shown in FIG. 7, process 700 may include obtaining account data associated with the delinquent account (block 720). For example, the debt resolution planning platform (e.g., using memory 430, storage component 440, input component 450, communication interface 470, and/or the like) may obtain account data associated with the delinquent account, as described above in FIGS. 1A-1C.

As further shown in FIG. 7, process 700 may include determining, using a first model, a score for the delinquent account based on the first input, the second input, the third input, and the account data, wherein the score predicts an ability to convert the delinquent account from a delinquent status to a current status (block 730). For example, the debt resolution planning platform (e.g., using processor 420, memory 430, storage component 440, communication interface 470, and/or the like) may determine a score for the delinquent account based on the first input, the second input, the third input, and the account data, as described above in FIGS. 1A-1C. In some implementations, the score predicts an ability to convert the delinquent account from a delinquent status to a current status.

As further shown in FIG. 7, process 700 may include determining, using a second model, a plurality of debt resolution plan parameters for at least a first debt resolution plan and a second debt resolution plan, based on the score, wherein the plurality of debt resolution plan parameters includes at least a first parameter indicating a repayment amount, a second parameter indicating a repayment frequency, and a third parameter indicating a repayment start date (block 740). For example, debt resolution planning platform (e.g., using processor 420, memory 430, storage component 440, communication interface 470, and/or the like) may determine a plurality of debt resolution plan parameters for at least a first debt resolution plan and a second debt resolution plan, based on the score, as described above in FIGS. 1A-1C. In some implementations, the plurality of debt resolution plan parameters includes at least a first parameter indicating a repayment amount, a second parameter indicating a repayment frequency, and a third parameter indicating a repayment start date.

As further shown in FIG. 7, process 700 may include transmitting the plurality of debt resolution plan parameters associated with the first debt resolution plan and the second debt resolution plan (block 750). For example, debt resolution planning platform (e.g., using storage component 440, output component 460, communication interface 470, and/or the like) may transmit the plurality of debt resolution plan parameters associated with the first debt resolution plan and the second debt resolution plan, as described above in FIGS. 1A-1C.

As further shown in FIG. 7, process 700 may include receiving an enrollment request based on transmitting the plurality of debt resolution plan parameters (block 760). For example, debt resolution planning platform (e.g., using storage component 440, input component 450, communication interface 470, and/or the like) may receive an enrollment request based on transmitting the plurality of debt resolution plan parameters, as described above in FIGS. 1A-1C.

As further shown in FIG. 7, process 700 may include enrolling the delinquent account in a selected debt resolution plan based on receiving the enrollment request (block 770). For example, debt resolution planning platform (e.g., using processor 420, memory 430, storage component 440, communication interface 470, and/or the like) may enroll the delinquent account in a selected debt resolution plan based on receiving the enrollment request, as described above in FIGS. 1A-1C.

As further shown in FIG. 7, process 700 may include suspending a collection activity associated with the delinquent account based on enrolling the delinquent account in the selected debt resolution plan, wherein the collection activity includes assigning a late fee to the delinquent account, assigning an interest amount to the delinquent account, or communicating a collection notice to a user associated with the delinquent account (block 780). For example, debt resolution planning platform (e.g., using processor 420, memory 430, storage component 440, input component 450, output component 460, communication interface 470, and/or the like) may suspend a collection activity associated with the delinquent account based on enrolling the delinquent account in the selected debt resolution plan, as described above in FIGS. 1A-1C. In some implementations, the collection activity includes assigning a late fee to the delinquent account, assigning an interest amount to the delinquent account, or communicating a collection notice to a user associated with the delinquent account.

Process 700 may include additional implementations, such as any single implementation or any combination of implementations described below and/or in connection with one or more other processes described elsewhere herein.

In some implementations, process 700 may include monitoring activity associated with the selected debt resolution plan, detecting completion of the selected debt resolution plan, and notifying a credit entity that the delinquent account is current or paid in full based on detecting completion of the selected debt resolution plan. In some implementations, process 700 may include monitoring activity associated with the selected debt resolution plan, determining noncompliance with the selected debt resolution plan, and terminating the selected debt resolution plan.

In some implementations, at least one of the first debt resolution plan or the second debt resolution plan includes a restorative plan by which the delinquent account converts to the current status upon completion. In some implementations, at least one of the first debt resolution plan or the second debt resolution plan includes an accelerated charge off plan by which the delinquent account is closed.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that the devices, systems, and/or methods, described herein, may be implemented in different forms of hardware, firmware, or a combination of hardware and software. The actual specialized control hardware or software code used to implement these devices, systems, and/or methods is not limiting of the implementations. Thus, the operation and behavior of the devices, systems, and/or methods were described herein without reference to specific software code—it being understood that software and hardware can be designed to implement the devices, systems, and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method, comprising:
receiving, by a device, a request for information regarding a debt resolution plan available for a delinquent account,
wherein the request includes:
a first input indicating a payment amount,
a second input indicating a payment frequency, and
a third input indicating a payment start date;
obtaining, by the device, account data associated with the delinquent account;
determining, by the device and using a first machine learning model, a score for the delinquent account based on the first input, the second input, the third input, and the account data,
wherein the first machine learning model is trained to receive the first input, the second input, the third input, and the account data and produce, as output, the score, and
wherein the score predicts an ability to convert the delinquent account from a delinquent status to a current status;
determining, by the device and using a second machine learning model, a plurality of debt resolution plan parameters, for at least a first debt resolution plan and a second debt resolution plan, based on the score,
wherein the second machine learning model is trained, based on historical account data, to receive at least a portion of the account data as input and produce, as output, the plurality of debt resolution plan parameters, and
wherein the plurality of debt resolution plan parameters includes at least:
a first parameter indicating a repayment amount,
a second parameter indicating a repayment frequency, and
a third parameter indicating a repayment start date;
transmitting, by the device, the plurality of debt resolution plan parameters associated with the first debt resolution plan and the second debt resolution plan;
receiving, by the device, an enrollment request based on transmitting the plurality of debt resolution plan parameters;
enrolling, by the device, the delinquent account in a selected debt resolution plan based on receiving the enrollment request; and
causing, by the device, an action to be performed based on enrolling the delinquent account in the selected debt resolution plan.

2. The method of claim 1, wherein at least one of the first debt resolution plan or the second debt resolution plan includes a restorative plan by which the delinquent account converts to the current status upon completion.

3. The method of claim 1, wherein at least one of the first debt resolution plan or the second debt resolution plan includes an accelerated charge off plan by which the delinquent account is closed.

4. The method of claim 1, wherein the action includes:
suspending or reducing late fees for the delinquent account,
suspending or reducing interest for the delinquent account,
reducing a minimum payment for the delinquent account, or
suspending collection communications for the delinquent account.

5. The method of claim 1, further comprising:
monitoring activity associated with the selected debt resolution plan;
detecting completion of the selected debt resolution plan; and
notifying a credit entity that the delinquent account is current or paid in full based on detecting completion of the selected debt resolution plan.

6. The method of claim 1, further comprising:
monitoring activity associated with the selected debt resolution plan;
determining noncompliance with the selected debt resolution plan; and
terminating the selected debt resolution plan.

7. The method of claim 1, wherein the account data includes:
a current interest rate for the delinquent account,
a current amount of fees associated with the delinquent account, or
a current minimum payment associated with the delinquent account.

8. The method of claim 1, wherein the delinquent account includes:
a credit card account, or
a loan account.

9. A device, comprising:
one or more memories; and
one or more processors, communicatively coupled to the one or more memories, to:
receive a request for information regarding a debt resolution plan available for a delinquent account,
wherein the request includes:
a first input indicating a payment amount,
a second input indicating a payment frequency, and
a third input indicating a payment start date;
obtain account data associated with the delinquent account;
determine, using a first machine learning model, a score for the delinquent account based on the first input, the second input, the third input, and the account data,
wherein the first machine learning model is trained to receive the first input, the second input, the third input, and the account data and produce, as output, the score, and
wherein the score predicts an ability to convert the delinquent account from a delinquent status to a current status;
determine, using a second machine learning model, a plurality of debt resolution plan parameters, for at least a first debt resolution plan and a second debt resolution plan, based on the score,
wherein the second machine learning model is trained, based on historical account data, to receive at least a portion of the account data as input and produce, as output, the plurality of debt resolution plan parameters, and
wherein the plurality of debt resolution plan parameters includes at least:
a first parameter indicating a repayment amount,
a second parameter indicating a repayment frequency, and
a third parameter indicating a repayment start date, and
wherein at least one of the first debt resolution plan or the second debt resolution plan includes a restorative plan by which the delinquent account converts to the current status upon completion;
transmit the plurality of debt resolution plan parameters associated with the first debt resolution plan and the second debt resolution plan;
receive an enrollment request based on transmitting the plurality of debt resolution plan parameters;
enroll the delinquent account in a selected debt resolution plan based on receiving the enrollment request; and
cause an action to be performed based on enrolling the delinquent account in the selected debt resolution plan.

10. The device of claim 9, wherein the action includes:
suspending or reducing late fees for the delinquent account,
suspending or reducing interest for the delinquent account,
reducing a minimum payment for the delinquent account, or
suspending collection communications for the delinquent account.

11. The device of claim 10, wherein the collection communications include communications delivered by way of electronic mail, telephone, and/or a postal service.

12. The device of claim 9, wherein the one or more processors are further to:
monitor activity associated with the selected debt resolution plan;
detect completion of the selected debt resolution plan; and
notify a credit entity that the delinquent account is current or paid in full based on detecting completion of the selected debt resolution plan.

13. The device of claim 9, wherein the one or more processors are further to:
monitor activity associated with the selected debt resolution plan;
determine noncompliance with the selected debt resolution plan; and
terminate the selected debt resolution plan.

14. The device of claim 9, wherein the request is received from a computing device.

15. The device of claim 9, wherein the one or more processors are further to:
generate and send an enrollment communication to a user.

16. A non-transitory computer-readable medium storing instructions, the instructions comprising:
one or more instructions that, when executed by one or more processors, cause the one or more processors to:
receive a request for information regarding a debt resolution plan available for a delinquent account,
wherein the request includes:
a first input indicating a payment amount,
a second input indicating a payment frequency, and
a third input indicating a payment start date;
obtain account data associated with the delinquent account;
determine, using a first machine learning model, a score for the delinquent account based on the first input, the second input, the third input, and the account data,
wherein the first machine learning model is trained to receive the first input, the second input, the third input, and the account data and produce, as output, the score, and
wherein the score predicts an ability to convert the delinquent account from a delinquent status to a current status;
determine, using a second machine learning model, a plurality of debt resolution plan parameters, for at least a first debt resolution plan and a second debt resolution plan, based on the score,
wherein the second machine learning model is trained, based on historical account data, to receive at least a portion of the account data as input and produce, as output, the plurality of debt resolution plan parameters, and
wherein the plurality of debt resolution plan parameters includes at least:
a first parameter indicating a repayment amount,
a second parameter indicating a repayment frequency, and
a third parameter indicating a repayment start date;
transmit the plurality of debt resolution plan parameters associated with the first debt resolution plan and the second debt resolution plan;
receive an enrollment request based on transmitting the plurality of debt resolution plan parameters;
enroll the delinquent account in a selected debt resolution plan based on receiving the enrollment request; and
suspend a collection activity associated with the delinquent account based on enrolling the delinquent account in the selected debt resolution plan,
wherein the collection activity includes:
assigning a late fee to the delinquent account,
assigning an interest amount to the delinquent account, or
communicating a collection notice to a user associated with the delinquent account.

17. The non-transitory computer-readable medium of claim 16, wherein the one or more instructions, when executed by the one or more processors, further cause the one or more processors to:
monitor activity associated with the selected debt resolution plan;
detect completion of the selected debt resolution plan; and
notify a credit entity that the delinquent account is current or paid in full based on detecting completion of the selected debt resolution plan.

18. The non-transitory computer-readable medium of claim 16, wherein the one or more instructions, when executed by the one or more processors, further cause the one or more processors to:
monitor activity associated with the selected debt resolution plan;
determine noncompliance with the selected debt resolution plan; and
terminate the selected debt resolution plan.

19. The non-transitory computer-readable medium of claim 16, wherein at least one of the first debt resolution plan or the second debt resolution plan includes a restorative plan by which the delinquent account converts to the current status upon completion.

20. The non-transitory computer-readable medium of claim 16, wherein at least one of the first debt resolution plan or the second debt resolution plan includes an accelerated charge off plan by which the delinquent account is closed.
